(19) United States
(12) Patent Application Publication
(10) Pub. No.: US 2024/0062675 A1
(43) Pub. Date: Feb. 22, 2024

(54) ACTION ESTIMATION SYSTEM AND RECORDING MEDIUM

(71) Applicant: Panasonic Intellectual Property Management Co., Ltd., Osaka (JP)

(72) Inventor: Yuka YAMAMOTO, Osaka (JP)

(21) Appl. No.: 18/260,729

(22) PCT Filed: Feb. 5, 2021
(86) PCT No.: PCT/JP2021/004238

§ 371 Date: Jul. 7, 2023

(51) Int. Cl. G09B 19/00

(52) U.S. Cl. CPC G09B 19/00

(57) ABSTRACT

An action estimation system includes: an obtainer that obtains at least one of schedule information or result information, the schedule information indicating a schedule of an action planned by a first user, the schedule of the action being for the first user in a predetermined period of time, the result information indicating an actual action of the first user in the predetermined period of time; a generator that generates first degree-of-interest information indicating a degree-of-interest of the first user for each of a plurality of actions based on the at least one of schedule information or result information obtained; and an estimator that estimates a first action that the first user is interested in other than the plurality of actions by comparing the first degree-of-interest information generated with each of a plurality of items of second degree-of-interest information each of which is generated for an other user.

### CROSS-REFERENCE OF RELATED APPLICATIONS

This application is the U.S. National Phase under 35 U.S.C. § 371 of International Patent Application No. PCT/JP2021/004238, filed on Feb. 5, 2021, the entire disclosure of which Application is incorporated by reference herein.

### TECHNICAL FIELD

The present invention relates to an action estimation system that estimates action that a user is interested in.

### BACKGROUND ART

It is described in Patent Literature (PTL) 1 to attach a voice output device to a desk for a preschooler, the voice output device including: a switch attached to a top plate; a voice output controller that includes a memory storing a series of words prompting specific actions (acts); and a speaker. In this desk for a preschooler, when the switch is pressed, the voice output controller sequentially outputs a series of words prompting a specific action from the speaker.

Furthermore, it is also described in PTL 1 that for each time zone, a series of words prompting a specific action corresponding to this time zone is associated, and a series of words prompting a specific action associated with the time zone when the switch is pressed is sequentially output audibly. Accordingly, every time the preschooler presses the switch, the voice output device sequentially outputs a series of words prompting specific actions audibly, so that the preschooler can perform the specific actions through conversation with the desk for a preschooler.

### CITATION LIST

### Patent Literature

[PTL 1] Japanese Unexamined Patent Application Publication No. 2013-287

### SUMMARY OF INVENTION

### Technical Problem

Incidentally, it is difficult to know what kind of actions a user is potentially interested in.

The present invention provides an action estimation system and the like that can estimate actions that a user is interested in.

### Solution to Problem

An action estimation system according to an aspect of the present invention includes: an obtainer that obtains at least one of schedule information or result information, the schedule information indicating a schedule of an action planned by a first user, the schedule of the action being for the first user in a predetermined period of time, the result information indicating an actual action of the first user in the predetermined period of time; a generator that generates first degree-of-interest information indicating a degree-of-interest of the first user for each of a plurality of actions based on the at least one of schedule information or result information obtained; and an estimator that estimates a first action that the first user is interested in other than the plurality of actions by comparing the first degree-of-interest information generated with each of a plurality of items of second degree-of-interest information each of which is generated for an other user.

An action estimation system according to an aspect of the present invention includes: an obtainer that obtains schedule information indicating a schedule of action planned by a user, the schedule of action being for the user in a predetermined period of time; and a generator that generates degree-of-interest information indicating a degree-of-interest of the user for each of a plurality of actions based on the schedule information obtained.

A recording medium according to an aspect of the present invention is a computer-readable non-transitory recording medium having recorded thereon a program for causing a computer to execute an information processing method, the information processing method including: receiving arrangement information from a toy that includes a plurality of blocks and a case accommodating the plurality of blocks, the toy allowing a user to change an arrangement of the plurality of blocks in the case, the arrangement information indicating the arrangement of the plurality of blocks in the case; generating schedule information indicating a schedule of actions of the user for a predetermined period of time based on the arrangement information received; and transmitting the schedule information generated to a server device.

### Advantageous Effects of Invention

The action estimation system and the like of the present invention can estimate actions that the user is interested in.

### BRIEF DESCRIPTION OF DRAWINGS

FIG. 1 is a block diagram showing the functional configuration of an action estimation system according to an embodiment.

FIG. 2 is an external perspective view of a toy according to the embodiment.

FIG. 3 is a diagram showing an example of a screen displayed on the display of the information terminal according to the embodiment.

FIG. 4 is a flowchart of Operation example 1 of the action estimation system according to the embodiment.

FIG. 5 is a diagram showing an example of schedule information and result information.

FIG. 6 is a diagram showing an example of first degree-of-interest information and second degree-of-interest information.

FIG. 7 is a diagram conceptually showing the processing performed by the machine learning model.

FIG. 8 is a diagram showing an example of an image showing a first action.

FIG. 9 is a flowchart of Operation example 2 of the action estimation system according to the embodiment.

FIG. 10 is a diagram showing an example of an image indicating the first degree-of-interest.

FIG. 11 is a flowchart showing a processing procedure of a program for operating a computer as an information terminal in the embodiment.

### DESCRIPTION OF EMBODIMENTS

Hereinafter, embodiments will be specifically described with reference to the drawings. It should be noted that the embodiments described below are all comprehensive or specific examples. Numerical values, shapes, materials, components, arrangement positions and connection forms of components, steps, order of steps, and the like shown in the following embodiments are examples and are not intended to limit the present invention. In addition, among the components in the following embodiments, components not described in independent claims will be described as optional components.

It should be noted that each figure is a schematic view and is not necessarily exactly illustrated. In addition, in each figure, the same symbol is denoted with respect to substantially the same configuration, and the overlapping description may be omitted or simplified.

In addition, terms that indicate timing such as “immediately after” and “immediately” used in the following embodiments should not be interpreted in a strict sense.

### Embodiment

### [Configuration]

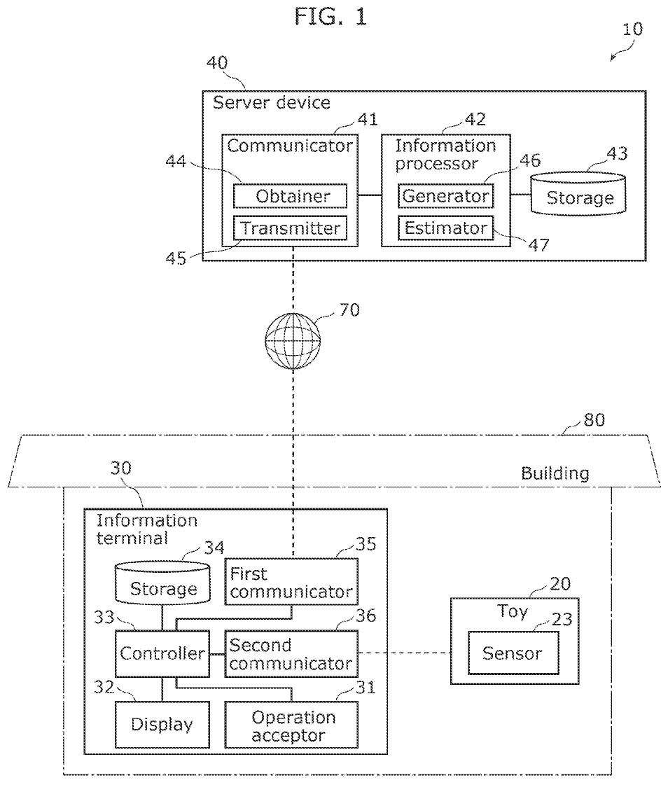

First, a configuration of an action estimation system according to an embodiment will be described. FIG. 1 is a block diagram showing the functional configuration of the action estimation system according to the embodiment.

Action estimation system 10 according to the embodiment is a system for estimating actions that a preschooler is interested in. Specifically, action estimation system 10 estimates the actions that the preschooler is interested in based on a schedule of actions that the preschooler makes with a parent or a nursery teacher (hereinafter referred to as a parent or the like) and actions actually performed by the preschooler.

As shown in FIG. 1, action estimation system 10 includes toy 20, information terminal 30, and server device 40. Toy 20 and information terminal 30 are installed, for example, in building 80. Building 80 is, for example, a residence such as an apartment complex or a detached house, but may be a childcare facility or the like.

### [Toy]

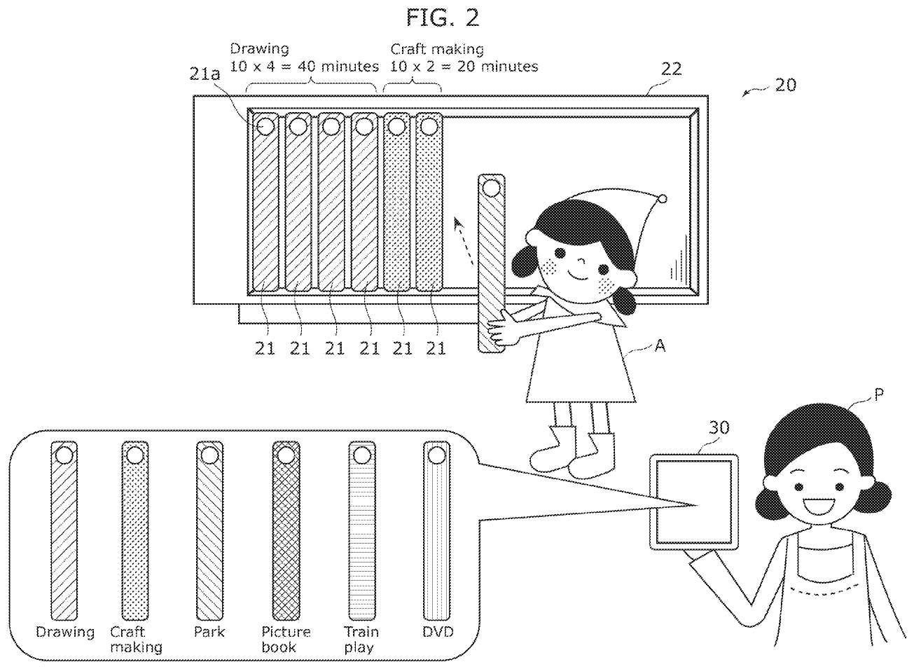

In action estimation system 10, toy 20 is used as a user interface for a preschooler to make a schedule for actions together with a parent or the like. First, the configuration of toy 20 will be described. FIG. 2 is an external perspective view of toy 20.

Toy 20 includes a plurality of long plate-shaped blocks 21, case 22 that accommodates the plurality of blocks 21, and sensor 23 (shown in FIG. 1) built into case 22.

The plurality of blocks 21 are classified into six types according to the color of the blocks 21. Six types of blocks 21 correspond to six types of actions. The six types of actions are actions that preschooler A can take, such as drawing, craft making, park, picture book, train play, and DVD. Which action is linked to which color block 21 is registered in storage 34 of information terminal 30 by parent P operating information terminal 30. That is, storage 34 stores correspondence relationship information indicating which action is linked to which color block 21 (more specifically, identification information issued by a wireless tag, which will be described later). It should be noted that for example, about 20 types of action candidates are prepared, and parent P or the like consults with preschooler A and selects 6 types from among the 20 types to be linked to the blocks. It should be noted that the number of types of blocks (6 in the above example) is not particularly limited.

Accommodating one block 21 in case 22 corresponds to make a schedule of the action indicated by the block 21 for a certain period of time (for example, 10 minutes). As shown in FIG. 2, when preschooler A arranges four blocks 21 in the color corresponding to “drawing” in succession on the left end of case 22, it corresponds to making a schedule of “drawing” for 40 minutes. Arranging two blocks in the color corresponding to “craft making” in succession immediately to the right of four blocks 21 in the color corresponding to “drawing” means making a schedule of “craft making” for 20 minutes after having performed “drawing” for 40 minutes.

Each of the plurality of blocks 21 includes a built-in wireless tag such as an RF tag, and the block 21 emits identification information from the built-in wireless tag. The wireless tag is, for example, a passive type, but may be an active type. Toy 20 can transmit the arrangement information indicating how blocks 21 are arranged in case 22 to information terminal 30 by sensing the identification information emitted by blocks 21 with sensor 23 such as a wireless tag reader.

More specifically, the arrangement information is information in which accommodation position information indicating the accommodation position of block 21 in case 22 (information indicating what number from the left, or the like) is associated with identification information of block 21 sensed at the accommodation position. Information terminal 30 can recognize what kind of action is scheduled by collating the arrangement information and the correspondence relationship information stored in storage 34.

In this way, according to toy 20, preschooler A can make his/her own schedule with a sense of play, and information terminal 30 can recognize the schedule that preschooler A has made. In other words, preschooler A can enter his/her own schedule into information terminal 30 with a sense of play.

In addition, according to toy 20, information terminal 30 can also recognize at what time preschooler A performed each action such as “drawing”. In the example of FIG. 2, when preschooler A actually starts “drawing”, push button 21a of one of four consecutively arranged blocks 21 in colors corresponding to “drawing” is pressed, and when preschooler A finishes “drawing”, push button 21a of one of four blocks 21 in colors corresponding to “drawing” is pressed again. Toy 20 transmits notification information to information terminal 30 each time push button 21a of block 21 in the color corresponding to “drawing” is pressed. Accordingly, information terminal 30 can recognize the first notification information reception time as the start time of “drawing”, and the second notification information reception time as the end time of “drawing”.

In this way, according to toy 20, preschooler A can press push button 21a with a sense of play to input what action he/she performed at what time (hereinafter also referred to as the result of the action) into information terminal 30.

### [Information Terminal]

Next, information terminal 30 will be described. Information terminal 30 is a general-purpose mobile terminal such as a smart phone, a tablet terminal or the like, but may be a dedicated terminal for action estimation system 10. Alternatively, information terminal 30 may be a home controller such as a home energy management system (HEMS) controller installed in building 80. Information terminal 30 specifically includes operation acceptor 31, display 32, controller 33, storage 34, first communicator 35 and second communicator 36.

Operation acceptor 31 accepts the operation of parent P or the like. Operation acceptor 31 accepts an operation (registration operation) for linking the color (type) of block 21 to an action, for example, from parent P or the like. Operation acceptor 31 is, for example, a capacitive touch panel, but may be a resistive touch panel.

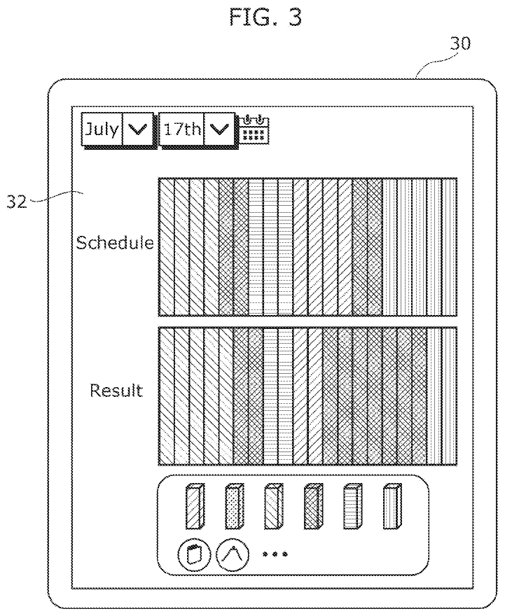

Display 32 displays images. Display 32 can display the schedule of the actions for preschooler A which has been input, for example, via toy 20 and the result of the actions of preschooler A. FIG. 3 is a diagram showing an example of a display screen of display 32. Display 32 is, for example, a display panel such as a liquid 15 crystal panel or an organic electro luminescence (EL) panel.

Controller 33 generates schedule information based on the schedule of the actions for preschooler A input via toy 20. Specifically, controller 33 regards the arrangement of the plurality of blocks 21 determined by the arrangement information received by second communicator 36 as the schedule of the actions for preschooler A planned by preschooler A, and generates the schedule information.

In addition, controller 33 generates result information based on the results of the actions for preschooler A input via toy 20. Specifically, controller 33 generates result information based on the notification information received by second communicator 36 in response to pressing of push button 21a provided in block 21.

In addition, controller 33 also controls the display of images on display 32, and the like. Controller 33 is realized by, for example, a microcomputer, but may be realized by a processor.

Storage 34 is a storage device in which programs and the like executed by controller 33 are stored. In addition, storage 34 also stores the correspondence relationship information mentioned above. Storage 34 is realized by, for example, a semiconductor memory or the like.

First communicator 35 is a communication module (communication circuit) for information terminal 30 to communicate with server device 40 via wide area communication network 70 such as the Internet. First communicator 35 transmits, for example, the schedule information and result information which have been generated by controller 33 to server device 40. The communication performed by first communicator 35 is, for example, wireless communication, but may be wired communication. The communication standard used for communication is also not particularly limited.

Second communicator 36 is a communication module (communication circuit) for information terminal 30 to communicate with toy 20 via the local communication network. Second communicator 36 receives, for example, the arrangement information and notification information which have been mentioned above from toy 20. The communication performed by second communicator 36 is, for example, wireless communication, but may be wired communication. The communication standard used for communication is also not particularly limited. It should be noted that communication between second communicator 36 and toy 20 conforms to, for example, Bluetooth (registered trademark) low energy (BLE).

### [Server Device]

Next, server device 40 will be described. Server device 40 is a cloud server that obtains schedule information and result information from information terminal 30 and performs information processing for estimating the action that preschooler A is interested in based on the obtained schedule information and result information. Server device 40 includes communicator 41, information processor 42 and storage 43.

Communicator 41 is a communication module (communication circuit) for server device 40 to communicate with information terminal 30 via wide area communication network 70. Specifically, communicator 41 includes obtainer 44 that obtains the schedule information and the result information, and transmitter 45 for transmitting, to information terminal 30, action information indicating the action that preschooler A is estimated to be interested in as a result of the above information processing. The communication performed by communicator 41 is, for example, wired communication, but may be wireless communication. The communication standard used for communication is also not particularly limited.

Information processor 42 performs information processing for estimating the action that preschooler A is interested in based on the schedule information and result information which have been obtained by obtainer 44. Information processor 42 specifically includes generator 46 and estimator 47. Information processor 42 is realized by, for example, a microcomputer, but may be realized by a processor.

Storage 43 is a storage device that stores programs executed by information processor 42 and various types of information used for the above information processing. In addition, storage 43 is realized by, for example, a hard disk drive (HDD).

[Operation example 1]

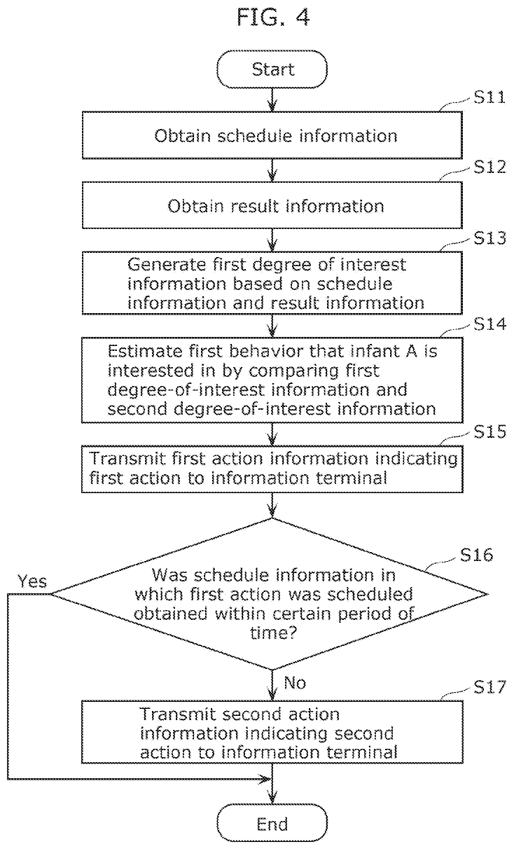

Operation example 1 of action estimation system 10 will be described below. FIG. 4 is a flowchart of operation example 1 of action estimation system 10.

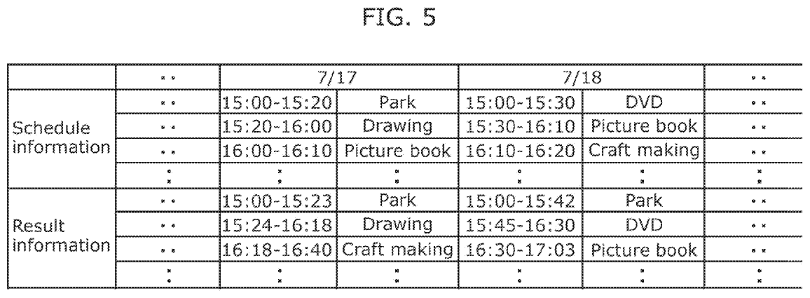

First, obtainer 44 of server device 40 obtains, from information terminal 30, the schedule information indicating the schedule of the actions for preschooler A in a predetermined period of time planned by preschooler A (S11). As shown in FIG. 5, the schedule information is information in which at least some of the about 20 types of actions mentioned above are associated with their scheduled times of day (time zones). FIG. 5 is a diagram showing an example of schedule information.

The predetermined period of time is, for example, one month, but is not particularly limited. Obtainer 44 may obtain schedule information every day to finally obtain one month's worth of schedule information, or may obtain one month's worth of schedule information accumulated in storage 34 of information terminal 30 all at once.

In addition, obtainer 44 obtains result information indicating the actual actions of preschooler A during the predetermined period of time described above from information terminal 30 (S12). FIG. 5 described above is also a diagram showing an example of the result information, and as shown in FIG. 5, the result information is information in which at least some of about 20 types of actions mentioned above are associated with their execution times of day (time zones).

Obtainer 44 may obtain result information every day to finally obtain one month's worth of schedule information, or may obtain one month's worth of result information accumulated in storage 34 of information terminal 30 at once.

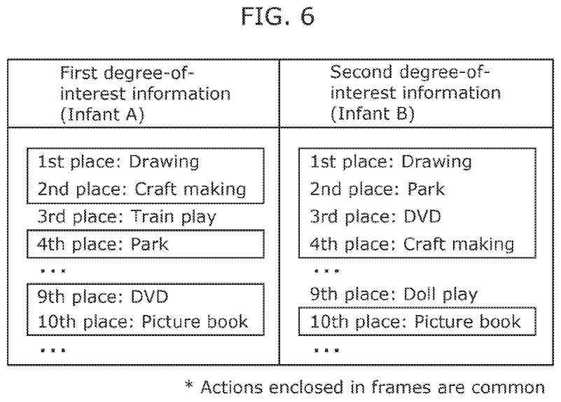

Next, generator 46 generates first degree-of-interest information indicating the degree-of-interest of preschooler A in each of the plurality of actions, based on the obtained schedule information and result information (S13). The first degree-of-interest information is, for example, information that ranks the degree-of-interest of preschooler A in a plurality of actions. FIG. 6 is a diagram showing an example of the first degree-of-interest information. In FIG. 6, second degree-of-interest information of preschooler B, which is different from preschooler A, is also shown.

The plurality of actions for which the degree-of-interest of preschooler A is indicated by the first degree-of-interest information includes actions which have been scheduled even once in one month's worth of schedule information (in other words, actions which have been linked to any of the six kinds of blocks even once during one month). However, the plurality of actions for which the degree-of-interest of preschooler A is indicated by the first degree-of-interest information do not include actions that have never been scheduled in one month's worth of schedule information (in other words, actions which have never been linked to any of the six kinds of blocks during one month).

As mentioned above, though six actions can be linked to the six types of blocks 21 at once, parent P or the like can change this linking in a daily basis, so that one month's worth of schedule information can include more than 6 types of actions. That is, as suggested in FIG. 6, the number of the plurality of actions described above may be greater than six. In the present embodiment, about 20 types of action candidates are prepared, and the number of the plurality of actions described above is 20 at maximum, but here for the sake of explanation, it is assumed that the number of the plurality of actions is about 15.

A method for generating the first degree-of-interest information by generator 46 will be described in details below. For example, for each of a plurality of actions included in one month's worth of schedule information, generator 46 calculates the total amount of time during which actions have been scheduled (that is, total scheduled time), the total number of times actions have been scheduled (that is, total number of scheduled times), and the change in scheduled time over time. It should be noted that the change in scheduled time over time is, for example, the difference between the length of time when the action is first scheduled and the length of time when the action is last scheduled.

In addition, for example, for each of the plurality of actions included in one month's worth of result information, generator 46 calculates the total amount of time during which actions have been executed (that is, total execution time), the total number of times actions have been executed (that is, the total number of execution times), and the change in execution time over time. It should be noted that the change in execution time over time is, for example, the difference between the length of time when the action is first executed and the length of time when the action is last executed.

Furthermore, generator 46 calculates the total execution time/total scheduled time, and the total number of execution times/total number of scheduled times.

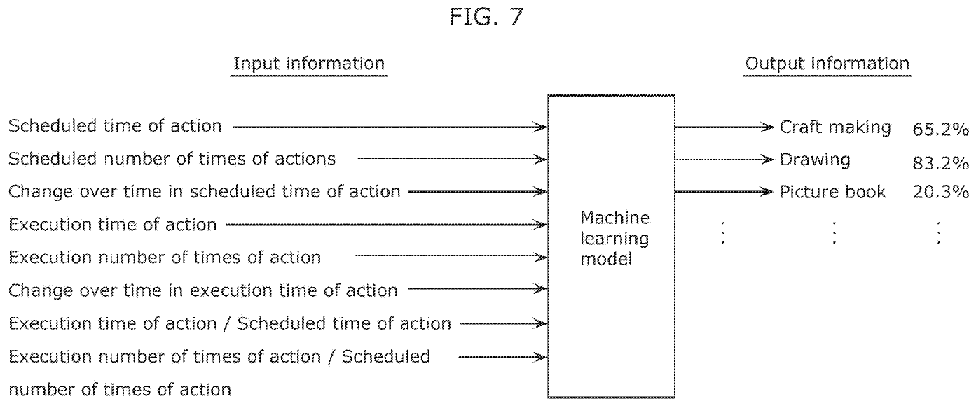

Then, generator 46 inputs the calculated information into a machine learning model constructed in advance. The machine learning model is a discriminator (classifier) constructed to output the degree-of-interest of preschooler A with respect to a plurality of actions included in one month's worth of the schedule information and result information using the calculated information as input information. FIG. 7 is a diagram conceptually showing the processing performed by the machine learning model. Generator 46 can generate the first degree-of-interest information by ranking the degree-of-interest in the plurality of actions output by the machine learning model. It should be noted that the machine learning model is constructed, for example, by supervised learning based on data obtained in advance from a plurality of subjects (preschoolers).

It should be noted that it is not essential that all the input information shown in FIG. 7 is used, and at least one item of input information may be used. For example, when only parameters calculated from schedule information are used as input information, the process of obtaining result information in step S12 may be omitted. Similarly, for example, when a parameter calculated from the execution information (such as execution time of an action) is used as the input information, the process of obtaining schedule information in step S11 may be omitted. That is, obtainer 44 may obtain at least one of the schedule information or the result information.

Here, generator 46 stores the first degree-of-interest information in storage 43. Generator 46 also stores in storage 43 the second degree-of-interest information generated in the past for preschooler B who is a preschooler other than preschooler A. That is, storage 43 accumulates a plurality of items of second degree-of-interest information each of which is generated for preschooler B.

Estimator 47 estimates the first action that preschooler A is interested in other than the plurality of actions included in one month's worth of the schedule and result information by comparing the generated first degree-of-interest information with a plurality of items of second degree-of-interest information (S14).

Specifically, estimator 47 identifies the second degree-of-interest information similar to the first degree-of-interest information from among the plurality of second degree-of-interest information by the above comparison (S14a). In other words, estimator 47 identifies preschooler B whose interest pattern is similar to that of preschooler A. For example, estimator 47 compares 10 types of actions belonging to the top 10 in the first degree-of-interest information with 10 types of actions belonging to the top 10 in the second degree-of-interest information, and the more the number of actions in common (up to 10), the more similar the second interest information is determined to be. In the example of FIG. 6 described above, the number of actions in common is five.

For example, estimator 47 identifies second degree-of-interest information having a predetermined number (for example, five) or more of the actions in common as similar second-degree-of-interest information. That is, estimator 47 identifies the second degree-of-interest information having a rank close to the rank of the first degree-of-interest information. Estimator 47 may identify the most similar second degree-of-interest information (having the largest number of actions in common) as the similar second degree-of-interest information. When there are a plurality of items of the identified second degree-of-interest information, one item may be selected at random, or further narrowing may be performed by evaluating the degree of similarity or the like in consideration of differences in ranking.

Then, estimator 47 estimates, among the actions included in the identified second degree-of-interest information, actions not included in the first degree-of-interest information as first actions that preschooler A is interested in. For example, when it is determined that the second degree-of-interest information of preschooler B shown in FIG. 6, “doll play” is selected as the first action.

It should be noted that if there are a plurality of actions that meet the requirements, all of these actions may be selected as the first actions, one may be selected at random, or the action with the highest ranking may be selected. In addition, when there are a plurality of actions that meet the requirements, estimator 47 may store actions that have not been selected as the first action among these actions in storage 43 as candidates for the second action described later.

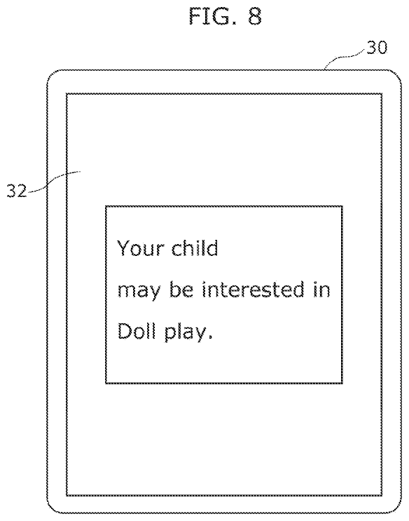

Next, transmitter 45 transmits first action information indicating the estimated first action to information terminal 30 (S15). When the first action information is received by first communicator 35, controller 33 of information terminal 30 causes display 32 to display an image indicating the first action based on the received first action information. FIG. 8 is a diagram showing an example of an image indicating the first action. In other words, the image in FIG. 8 is an image that recommends that parent P or the like associates the first action that has not been linked to block 21 of toy 20 with block 21 (perform a registration operation).

Furthermore, estimator 47 determines whether obtainer 44 obtains the schedule information in which the first action is scheduled within a certain period of time after transmitter 45 transmits the first action information (S16). A certain period of time is, for example, one month, but is not particularly limited. A case where it is determined that the schedule information in which the first action is scheduled within a certain period of time has been obtained (Yes in S16) means, in other words, that parent P or the like has watched the image in step FIG. 8 to perform the registration operation in which the first action is linked to one of the six types of blocks 21. In this case, the operation is terminated.

On the other hand, a case where it is determined that the schedule information in which the first action is scheduled within a certain period of time is not obtained (No in S16) means, in other words, that parent P or the like has performed no registration operation in which the first action is linked to one of the six types of blocks 21. In such a case, transmitter 45 transmits second action information indicating a second action different from the first action to information terminal 30 in order to recommend another action to parent P or the like (S17).

The second action may be estimated by the processing of steps S11 to S14 again, or may be selected from among the candidates for the second action when the candidates for the second action are stored in storage 43 when estimating the first action as described above.

As described above, action estimation system 10 can estimate the action that preschooler A is interested in and present it to parent P or the like. As mentioned above, in action estimation system 10, the linking of the six types of blocks to actions is performed by parent P or the like. That is, parent P or the like selects actions for preschooler A.

Here, such a research result is known that in order to improve preschooler A's sense of self-esteem and to develop his/her independence, it is important for preschooler A to take actions that he/she is interested in. In order for preschooler A to take an action that he/she is interested in, it would be good if parent P or the like could perform the above linking assuming various actions of preschooler A, but parent P or the like tends to unconsciously limit the actions due to the belief that “My child should be interested in . . . ”. Action estimation system 10 can help parent P or the like, who tends to unconsciously limit the actions, to discover actions that preschooler A is interested in.

### Operation Example 2

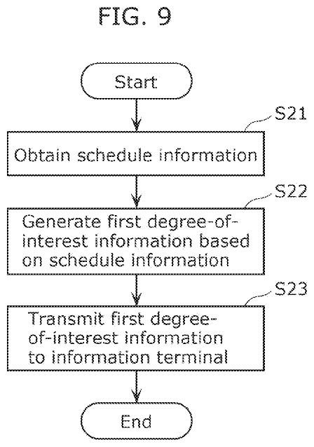

Action estimation system 10 can also provide the first degree-of-interest information to parent P or the like. Operation example 2 of such action estimation system 10 will be described below. FIG. 9 is a flowchart of Operation example 2 of action estimation system 10. It should be noted that Operation example 2 is an operation example in which the execution information is not used, but the execution information may be further used as in Operation example 1.

First, obtainer 44 of server device 40 obtains, from information terminal 30, the schedule information indicating the schedule of the actions for preschooler A during a predetermined period of time planned by preschooler A (S21). As shown in FIG. 5, the schedule information is information in which at least some of the about 20 types of actions mentioned above are associated with their scheduled times of day (time zones).

Next, generator 46 generates first degree-of-interest information indicating the degree-of-interest of preschooler A in each of the plurality of actions, based on the obtained schedule information (S22). As shown in FIG. 6 described above, the first degree-of-interest information is, for example, information that ranks the degree-of-interest of preschooler A in a plurality of actions. Generator 46 generates the first degree-of-interest information by using a machine learning model whose input information includes, for example, the scheduled time, the scheduled number of times, and the change over time in the scheduled time.

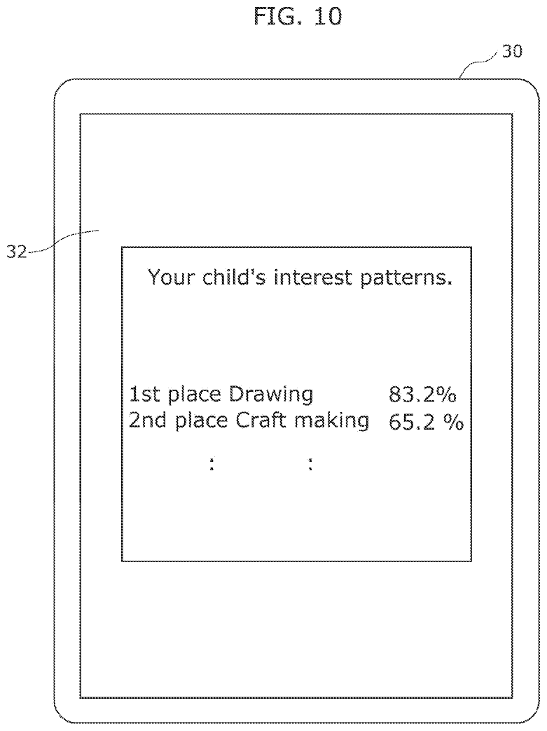

Next, transmitter 45 transmits the generated first degree-of-interest information to information terminal 30 (S23). First communicator 35 of information terminal 30 receives the first degree-of-interest information, and when first communicator 35 receives the first degree-of-interest information, controller 33 causes display 32 to display the image indicating the first degree-of-interest information based on the received first degree-of-interest information. FIG. 10 is a diagram showing an example of an image indicating first degree-of-interest information.

As described above, action estimation system 10 can estimate the degree-of-interest of preschooler A in each action and present the estimation result to parent P or the like. That is, action estimation system 10 can assist parent P or the like in discovering the actions that preschooler A is interested in.

### [Variations]

In the above embodiment, toy 20 was used as the user interface. However, the schedule of the actions for preschooler A and the result of the action of preschooler A may be directly input by operating operation acceptor 31 of information terminal 30. That is, action estimation system 10 may not include toy 20.

In addition, in the above embodiment, a machine learning model was used to generate the first degree-of-interest information, but the use of a machine learning model is not essential. For example, a method that the total scheduled time for each of a plurality of actions included in one month's worth of schedule information is calculated and ranked in order of total scheduled time is conceivable as the simplest method for generating the first degree-of-interest information. It is also possible to generate the first degree-of-interest information by a similar method using a parameter other than the scheduled time (scheduled number of times, execution time, or the like). In this way, a statistical method may be used to generate the first degree-of-interest information.

In addition, in the above embodiment, action estimation system 10 targets preschoolers, but may target people in age groups other than preschoolers, such as the elderly. Action estimation system 10 can target various users to propose actions that the users have not noticed and that the users are considered to be interested in.

### [Effects, etc.]

In Operation example 1, action estimation system 10 includes: obtainer 44 that obtains at least one of schedule information or result information, the schedule information indicating a schedule of an action planned by a first user, the schedule of the action being for the first user in a predetermined period of time, the result information indicating an actual action of the first user in the predetermined period of time; generator 46 that generates first degree-of-interest information indicating a degree-of-interest of the first user for each of a plurality of actions based on the at least one of schedule information or result information obtained; and estimator 47 that estimates a first action that the first user is interested in other than the plurality of actions by comparing the first degree-of-interest information generated with each of a plurality of items of second degree-of-interest information each of which is generated for an other user. In the above embodiment, the first user is preschooler A.

Such action estimation system 10 can estimate the action that preschooler A is interested in when the first user is preschooler A.

In addition, for example, estimator 47 performs the comparison described above to identify second degree-of-interest information similar to the first degree-of-interest information from among the plurality of items of second degree-of-interest information, and the action included in the identified second degree-of-interest information is estimated as the first action.

Such action estimation system 10 can estimate the first action that the first user is interested in based on the second degree-of-interest information similar to the first degree-of-interest information.

In addition, for example, the first degree-of-interest information indicates a rank of the degree-of-interest of the first user for the plurality of actions. Estimator 47 identifies, from among the plurality of items of second degree-of-interest information, second degree-of-interest information having a rank close to the rank of the first degree-of-interest information by the comparison, and estimates actions included in the identified second degree-of-interest information as the first actions.

Such action estimation system 10 can estimate the first action that the first user is interested in based on the second degree-of-interest information having a rank close to the rank of the first degree-of-interest information.

In addition, for example, obtainer 44 obtains both schedule information and result information. Generator 46 generates the first degree-of-interest information using one or more items of information which are determined based on the schedule information and the result information which are obtained, the one or more items of information including a scheduled time of the action, a scheduled number of times of the action, a change over time of the scheduled time of the action, an execution time of the action, an execution number of times of the action, a change over time of the execution time of the action, the execution time of the action/the scheduled time of the action, and the execution number of times of the action/the scheduled number of times of the action.

Such action estimation system 10 can use one or more of these parameters to generate first degree-of-interest information.

In addition, for example, obtainer 44 obtains the at least one of schedule information or result information from information terminal 30. Action estimation system 10 further includes transmitter 45 that transmits first action information indicating the estimated first action to the information terminal.

Such action estimation system 10 can use one or more of these parameters to generate first degree-of-interest information.

In addition, for example, when the schedule information indicating that the first action is scheduled has not been obtained by obtainer 44 for a certain period of time after the first action information is transmitted, transmitter 45 transmits second action information to information terminal 30, the second action information indicating a second action that the first user is estimated to be interested in other than the plurality of actions, the second action being different from the first action.

Such action estimation system 10 can assist the owner of information terminal 30 (parent P or the like) in discovering actions that the first user (preschooler A) is interested in.

In addition, for example, action estimation system 10 further includes information terminal 30, and information terminal 30 includes: first communicator 35 that receives the first action information; and display 32 that displays an image indicating the first action based on the first action information received.

Such action estimation system 10 can assist the owner of information terminal 30 (parent P or the like) in discovering the actions that the first user (preschooler A) is interested in by displaying an image indicating the first action on display 32.

In addition, for example, the first user is preschooler A, and action estimation system 10 further comprises toy 20 that includes a plurality of blocks 21 and case 22 accommodating the plurality of blocks 21, toy 20 allowing the first user to change an arrangement of the plurality of blocks 21 in case 22. Information terminal 30 further includes: second communicator 36 that receives, from toy 20, arrangement information indicating the arrangement of the plurality of blocks 21 in case 22; and controller 33 that regards the arrangement of the plurality of blocks 21 determined by the arrangement information received as the schedule of the action of the first user during the predetermined period of time planned by the first user, and generates the schedule information.

Such action estimation system 10 can estimate the actions that preschooler A is interested in based on the schedule information determined by preschooler A arranging blocks 21 in case 22.

In addition, in Operation example 2, action estimation system 10 includes: obtainer 44 that obtains schedule information indicating a schedule of action planned by a user, the schedule of action being for the user in a predetermined period of time; and generator 46 that generates first degree-of-interest information indicating a degree-of-interest of the user for each of a plurality of actions based on the schedule information obtained. In the above embodiment, the first user is preschooler A.

Such action estimation system 10 can estimate the actions that preschooler A is interested in when the first user is preschooler A.

In addition, for example, obtainer 44 obtains the schedule information from information terminal 30. Action estimation system 10 further includes transmitter 45 that transmits the first degree-of-interest information to information terminal 30.

Such action estimation system 10 can assist the owner of information terminal 30 (parent P or the like) in discovering actions that the first user (preschooler A) is interested in.

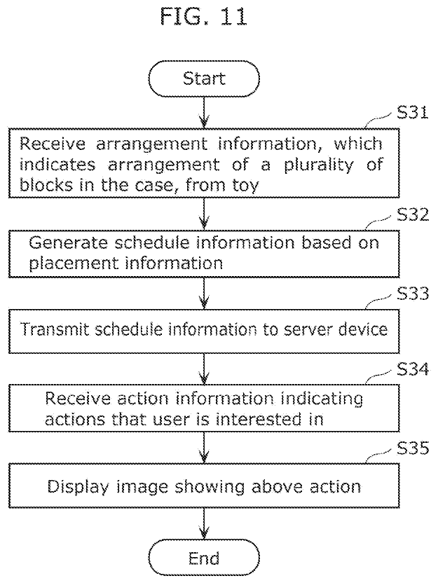

In addition, a program for operating a general-purpose computer as information terminal 30 performs processing as shown in FIG. 11. FIG. 11 is a flow chart showing the processing procedure of such a program. This program is a program for causing a computer to execute an information processing method, which includes: a first receiving step (S31) of receiving arrangement information from toy 20 that includes a plurality of blocks 21 and case 22 accommodating the plurality of blocks 21, toy 20 allowing a user to change an arrangement of the plurality of blocks 21 in case 22, the arrangement information indicating the arrangement of the plurality of blocks 21 in case 22; a generating step (S32) of generating schedule information indicating a schedule of actions of the user for a predetermined period of time based on the arrangement information received; and a transmission step (S33) of transmitting the schedule information generated to server device 40. In the above embodiment, the user is preschooler A.

Such a program can cause the computer to transmit, to server device 40, schedule information determined by preschooler A arranging blocks 21 in case 22. That is, such a program can assist server device 40 in estimating the actions that preschooler A is interested in.

In addition, for example, the information processing method includes a second receiving step (S34) of receiving, from server device 40, action information indicating an action that the user is interested in, the action being estimated by server device 40 after the transmitting (S33); and a display step (S35) of displaying an image indicating the action described above based on the action information received.

Such a program can assist the owner of the computer (parent P or the like) in discovering the action that the user (preschooler A) is interested in by displaying the image indicating the action described above.

### OTHER EMBODIMENTS

Although the embodiment has been described above, the present invention is not limited to the above embodiment.

For example, in the above embodiment, the action estimation system was realized by a plurality of devices, but it may be realized as a single device. For example, the action estimation system may be realized as a single device corresponding to the server device. When the action estimation system is realized by a plurality of devices, the components included in the action estimation system may be distributed to the plurality of devices in any way.

For example, the communication method between devices in the above embodiment is not particularly limited. In addition, a relay device (not shown) may intervene in communication between devices.

In addition, in the above embodiment, the processing executed by a specific processor may be executed by another processor. In addition, the order of the plurality of processes may be changed, and the plurality of processes may be executed in parallel. In addition, Operation example 1, Operation example 2, and Variations of the above embodiment may be combined arbitrarily.

In addition, in the above embodiment, each component may be realized by executing a software program suitable for each component. Each component may be realized by a program executer, such as a CPU or processor, reading and executing a software program recorded in a recording medium such as a hard disk or a semiconductor memory.

In addition, each component may be realized by hardware. For example, each component may be a circuit (or integrated circuit). These circuits may constitute one circuit as a whole, or may be separate circuits, respectively. In addition, these circuits may be general-purpose circuits or dedicated circuits, respectively.

In addition, general or specific aspects of the present invention may be realized in a system, device, method, integrated circuit, computer program, or recording medium such as a computer-readable CD-ROM. In addition, it may be achieved in any combination of systems, devices, methods, integrated circuits, computer programs, and recording media.

For example, the present invention may be realized as an action estimation method executed by a computer in an action estimation system or the like, or may be realized as a program for causing a computer to execute such an action estimation method. In addition, the present invention may be realized as a program for operating a general-purpose computer as the information terminal in the embodiments described above. The present invention may be realized as a computer-readable non-transitory recording medium having these programs recorded thereon.

In addition, forms obtained by applying various modifications to each embodiment conceived by a person skilled in the art or forms realized by arbitrarily combining the components and functions in each embodiment without departing from the spirit of the present invention are also included in the present invention.

### REFERENCE SIGNS LIST

10 Action estimation system
20 Toy
21 Block
22 Case
30 Information terminal
31 Operation acceptor
32 Display
33 Controller
34 Storage
35 First communicator
36 Second communicator
40 Server device
41 Communicator
42 Information processor
43 Storage
44 Obtainer
45 Transmitter
46 Generator
47 Estimator
A, B Preschooler
P Guardian

1. An action estimation system comprising:
an obtainer that obtains at least one of schedule information or result information, the schedule information indicating a schedule of an action planned by a first user, the schedule of the action being for the first user in a predetermined period of time, the result information indicating an actual action of the first user in the predetermined period of time;
a generator that generates first degree-of-interest information indicating a degree-of-interest of the first user for each of a plurality of actions based on the at least one of schedule information or result information obtained; and
an estimator that estimates a first action that the first user is interested in other than the plurality of actions by comparing the first degree-of-interest information generated with each of a plurality of items of second degree-of-interest information each of which is generated for an other user.

2. The action estimation system according to claim 1,
wherein the estimator identifies, from among the plurality of second degree-of-interest information, second degree-of-interest information similar to the first degree-of-interest information by the comparing, and estimates that an action included in the second degree-of-interest information identified is the first action.

3. The action estimation system according to claim 2,
wherein the first degree-of-interest information indicates a rank of the degree-of-interest of the first user for the plurality of actions, and
the estimator identifies, from among the plurality of second degree-of-interest information, second degree-of-interest information having a rank close to the rank of the first degree-of-interest information by the comparing, and estimates that an action included in the second degree-of-interest information identified is the first action.

4. The action estimation system according to claim 1,
wherein the obtainer obtains both the schedule information and the result information, and
the generator generates the first degree-of-interest information using one or more items of information which are determined based on the schedule information and the result information which are obtained, the one or more items of information including a scheduled time of the action, a scheduled number of times of the action, a change over time of the scheduled time of the action, an execution time of the action, an execution number of times of the action, a change over time of the execution time of the action, the execution time of the action/the scheduled time of the action, and the execution number of times of the action/the scheduled number of times of the action.

5. The action estimation system according to claim 1,
wherein the obtainer obtains the at least one of schedule information or result information from an information terminal, and
the action estimation system further includes a transmitter that transmits first action information indicating the first action estimated to the information terminal.

6. The action estimation system according to claim 5,
wherein when the schedule information indicating that the first action is scheduled has not been obtained by the obtainer for a certain period of time after the first action information is transmitted, the transmitter transmits second action information to the information terminal, the second action information indicating a second action that the first user is estimated to be interested in other than the plurality of actions, the second action being different from the first action.

7. The action estimation system according to claim 5, further comprising:
the information terminal,
wherein the information terminal includes:
a first communicator that receives the first action information; and
a display that displays an image indicating the first action based on the first action information received.

8. The action estimation system according to claim 7,
wherein the first user is a preschooler,
the action estimation system further comprises a toy that includes a plurality of blocks and a case accommodating the plurality of blocks, the toy allowing the first user to change an arrangement of the plurality of blocks in the case, and
the information terminal further includes:
a second communicator that receives, from the toy, arrangement information indicating the arrangement of the plurality of blocks in the case; and
a controller that regards the arrangement of the plurality of blocks determined by the arrangement information received as the schedule of the action of the first user during the predetermined period of time planned by the first user, and generates the schedule information.

9. An action estimation system comprising:
an obtainer that obtains schedule information indicating a schedule of action planned by a user, the schedule of action being for the user in a predetermined period of time; and
a generator that generates degree-of-interest information indicating a degree-of-interest of the user for each of a plurality of actions based on the schedule information obtained.

10. The action estimation system according to claim 9,
wherein the obtainer obtains the schedule information from an information terminal, and
the action estimation system further includes a transmitter that transmits the degree-of-interest information to the information terminal.

11. A computer-readable non-transitory recording medium having recorded thereon a program for causing a computer to execute an information processing method, the information processing method including:
receiving arrangement information from a toy that includes a plurality of blocks and a case accommodating the plurality of blocks, the toy allowing a user to change an arrangement of the plurality of blocks in the case, the arrangement information indicating the arrangement of the plurality of blocks in the case;
generating schedule information indicating a schedule of actions of the user for a predetermined period of time based on the arrangement information received; and
transmitting the schedule information generated to a server device.

12. The recording medium according to claim 11,
wherein the information processing method further includes:
receiving, from the server device, action information indicating an action that the user is interested in, the action being estimated by the server device after the transmitting; and
displaying an image indicating the action based on the action information received.
